(19) United States
(12) Patent Application Publication
(10) Pub. No.: US 2025/0278314 A1
(43) Pub. Date: Sep. 4, 2025

(54) CPU Performance Hint for Inference Workloads

(71) Applicant: Advanced Micro Devices, Inc., Santa Clara, CA (US)

(72) Inventor: Indrani Paul, Austin, TX (US)

(73) Assignee: Advanced Micro Devices, Inc., Santa Clara, CA (US)

(21) Appl. No.: 19/005,972

(22) Filed: Dec. 30, 2024

Related U.S. Application Data
(60) Provisional application No. 63/561,100, filed on Mar. 4, 2024.

(51) Int. Cl. G06F 9/50; G06F 1/3296

(52) U.S. Cl. CPC G06F 9/5094; G06F 1/3296; G06F 9/505

(57) ABSTRACT

A power manager of an apparatus receives priority and quality-of-service (QOS) parameters (e.g., latency, throughput) for an inference workload. An application, for instance, specifies the priority and QoS parameters for an inference workload to be processed using a central processing unit. The priority and QoS parameters are employed by the power manager as a basis to configure the power setting of the central processing unit. In particular, resource prioritization for central processing units is extended to both real-time and best-effort workloads to satisfy specified QoS parameters for inference workloads.

### CROSS-REFERENCE TO RELATED APPLICATION

This application claims priority to U.S. Provisional Patent Application No. 63/561,100, filed Mar. 4, 2024, and entitled “CPU Performance Hint for Inference Workloads,” the content of which is incorporated herein by reference in its entirety.

### BACKGROUND

Inference models (e.g., machine learning and trained artificial intelligence (AI) models) are increasingly used to improve task accuracy and efficiency. The speed of inference applications depends partly on the allocated frequency of a central processing unit (CPU) made available. CPUs, however, are generally implemented in devices that employ power-saving policies, which increasingly result in insufficient bandwidth for many inference workloads, especially those running in the background.

### BRIEF DESCRIPTION OF THE DRAWINGS

The detailed description is described with reference to the accompanying figures.

FIG. 1 is a block diagram of a processing system configured to execute one or more applications in accordance with one or more implementations.

FIG. 2 is a block diagram of a non-limiting example system to implement techniques to provide a CPU performance hint for inference workloads.

FIG. 3 is a block diagram of an example framework for providing a CPU performance hint for inference workloads.

FIG. 4 is a block diagram of an example system showing the operation of a power manager and a hardware driver to provide a CPU performance hint for inference workloads.

### DETAILED DESCRIPTION

The hardware design of processors continually evolves to provide ever-increasing amounts and varieties of functionality in support of corresponding increases in application functionality. For example, processors and processor cores of CPUs have increased computational power to address the increasing demand for inference and other machine-learning applications. As a result, managing the resources allocated for executing workloads (e.g., inference and AI workloads) using various hardware designs and operating policies has also experienced a corresponding increase in complexity, sometimes hindering device operation. For example, a priority parameter differentiates between real-time and non-real-time (e.g., normal priority or best-effort) workloads. In operation scenarios, applications typically default to identifying as “real-time” workloads, resulting in multiple workload requests causing performance or efficiency degradation (e.g., accessing a memory system). In another example, high-level hints indicate desired modes of operation but do not provide insight into actual resource utilization and processing goals for a corresponding workload. This often results in inefficient resource allocation and suboptimal performance of inference workloads.

In yet another example, a CPU coordinates the processing of inference workloads, including offloading portions of the workload to accelerator units and other hardware compute units. If the CPU is not allocated sufficient resources, the CPU can introduce a bottleneck for carrying out inference workloads, even if the accelerator units have sufficient resources.

To solve these various issues, a power manager of a client (e.g., a CPU) exposes an application programming interface (API) to applications to specify priority and QoS parameters (e.g., latency, throughput, deadline, computational time). A client, for instance, specifies the QoS parameters for processing a workload. In an example involving image processing, the priority parameter identifies the workload as “real-time,” and the QoS parameters specify a processing rate of thirty frames per second with a thirty-millisecond latency for use in object recognition by a machine-learning model executed by the hardware compute unit.

The power manager employs the priority and QoS parameters to configure clock speeds or operating voltages of a processor unit, e.g., a CPU with multiple processor cores, one of which is employed to implement the inference workload. The clock speeds or operating voltages are configured such that the processing resources available for the workload comply with the QoS parameters. The power manager, for instance, configures a partition to have sufficient processing resources (e.g., clock speed to implement a machine-learning model) to support the QoS parameters. This improves device operation through targeted optimization of computational resources and reduces power consumption.

Other insights are also usable by the power manager to handle inference workloads and satisfy corresponding priority and QoS parameters. In one example, workload statistics are obtained that describe processing characteristics for the workload (e.g., the number of operations to be performed and data movement between layers of a machine-learning model). The workload statistics, for instance, are obtained from heuristics generated from prior knowledge of hardware and/or firmware for the machine-learning model.

In another example, the power manager employs operation data to set power settings. The operation data for a CPU includes resource consumption by other partitions, partition availability, resource consumption by other hardware compute units (e.g., accelerator units), temperature, or power usage. In this way, the power manager optimizes the operation of the CPU based on insight gained into a workload to be processed or the device's computing environment.

In yet another example, the power manager determines potential power settings or sets a power setting for a particular workload based on power modes (e.g., power-slider position, power source). For example, a “best battery” or “best efficiency” power-slider position or power mode limits the type of power settings available.

In some aspects, the techniques described herein relate to a device comprising a power manager configured to send a priority parameter and a quality-of-service (QOS) parameter for processing an inference workload of the application, configure a processor core of a central processing unit of the device to process the inference workload at a first power setting among multiple power settings based on the priority parameter and the QoS parameter, and adjust the first power setting to a second power setting among the multiple power settings based on a performance of the inference workload in comparison to the QoS parameter.

In some aspects, the techniques described herein relate to a device wherein the power manager is further configured to assign the power setting based on a power setting assigned to one or more other hardware compute units of the device to perform additional processing of the inference workload.

In some aspects, the techniques described herein relate to a device wherein the processor core is configured to manage the additional processing of the inference workload by the one or more other hardware compute units.

In some aspects, the techniques described herein relate to a device wherein the one or more other hardware compute units include at least one of graphics processing units, neural processing units, artificial intelligence processors, inference engines, machine-learning processors, accelerator units, or programmable logic devices.

In some aspects, the techniques described herein relate to a device wherein the power manager is further configured to receive operation data that describes operation characteristics of the processor core and the one or more other hardware compute units and determine the first power setting based at least in part on the priority parameter, the QOS parameter, and the operation data.

In some aspects, the techniques described herein relate to a device wherein the power manager is further configured to, in response to the priority parameter indicating a best-effort priority, the QoS parameter specifying a latency or throughput for the inference workload, and a power-mode setting being satisfied by the processor core, assign a soft-minimum power setting associated with the inference workload that ensures the QoS parameter is satisfied.

In some aspects, the techniques described herein relate to a device wherein the power-mode setting is based on whether the device is powered by alternating-current (AC) power or direct-current (DC) power or a power-slider position for the central processing unit, the power-slider position including at least two of a best power efficiency setting, one or more balanced power efficiency and performance settings, or a best performance setting.

In some aspects, the techniques described herein relate to a device wherein the power manager is further configured to, in response to the application not specifying the QoS parameter, assign no minimum power setting associated with the inference workload and determine the first power setting based on the power-mode setting.

In some aspects, the techniques described herein relate to a method comprising receiving an input from an application, the input specifying a priority parameter for processing an inference workload associated with the application, determining, based at least in part on the priority parameter, a first power setting from among multiple power settings to process the inference workload, each power setting of the multiple power settings identifying a voltage and a frequency at which to operate a processor core of a central processing unit in a device, and processing the inference workload from the application by the processor core at the first power setting.

In some aspects, the techniques described herein relate to a method wherein the method further comprises, in response to the priority parameter indicating a real-time priority and the input also specifying a quality-of-service (QOS) parameter for the inference workload, assigning a second power setting from among the multiple power settings to the processor core to process the inference workload that satisfies the QoS parameter, in response to the priority parameter indicating a best-effort priority and the input also specifying the QoS parameter for the inference workload, assigning a third power setting to the processor core to process the inference workload that satisfies the QoS parameter or a power mode of the central processing unit, or in response to the input not specifying the QoS parameter for the inference workload, assigning a fourth power setting that satisfies the power mode.

In some aspects, the techniques described herein relate to a method wherein in response to a power setting based on the power mode consuming more power than a power setting based on the QoS parameter, the power setting based on the QoS parameter is selected as the third power setting, or in response to the power setting based on the QoS parameter consuming more power than the power setting based on the power mode, the power setting based on the power mode is selected as the third power setting.

In some aspects, the techniques described herein relate to a method wherein the multiple power settings are arranged in a power-level table by descending amounts of power consumption per power setting, and potential power settings available in the power-level table are determined at least in part by the power mode of the central processing unit and one or more other hardware compute units associated with processing of the inference workload.

In some aspects, the techniques described herein relate to a method wherein the method further comprises receiving workload statistics describing the inference workload, and determining the first power setting is based at least in part on the priority parameter and the workload statistics.

In some aspects, the techniques described herein relate to a method wherein the workload statistics specify a number of operations or amount of data movement to be performed by the processor core or one or more other hardware compute units.

In some aspects, the techniques described herein relate to a method wherein the workload statistics are determined based on prior knowledge of processing the inference workload by the processor core and the one or more other hardware compute units.

In some aspects, the techniques described herein relate to a method wherein the inference workload includes execution of a machine-learning model selected from a plurality of precompiled machine-learning models.

In some aspects, the techniques described herein relate to a method wherein the method further comprises receiving operation data that describes operating characteristics of one or more other hardware compute units in the device, and determining the first power setting is based at least in part on the priority parameter and the operation data of the one or more other hardware compute units.

In some aspects, the techniques described herein relate to a method wherein the one or more other hardware compute units include at least one of graphics processing units, neural processing units, artificial intelligence processors, inference engines, machine-learning processors, accelerator units, or programmable logic devices.

In some aspects, the techniques described herein relate to a central processing unit comprising a power manager configured to receive an input from an application that specifies a priority parameter, a quality-of-service (QOS) parameter, and workload statistics for processing an inference workload of the application to be processed by a processor core of multiple processor cores, and determine a power setting of the processor core to process the inference workload, the power setting determined to minimize power consumption in processing the inference workload and based at least in part on the workload statistics, the priority parameter, and the QoS parameter, and the processor core of the multiple processor cores, the processor core configured to generate a partition in the processor core based on the power setting; and process the inference workload using the generated partition.

In some aspects, the techniques described herein relate to a central processing unit wherein the power manager is further configured to, in response to the priority parameter indicating a real-time priority and the QoS parameter being specified, determine the power setting to ensure satisfaction of the QoS parameter, in response to the priority parameter indicating a best-effort priority and the QoS parameter being specified, determine the power setting to ensure satisfaction of the QoS parameter or compliance with a power-mode setting associated with the processor core, or in response to the QoS parameter not being specified, determine the power setting to ensure compliance with the power-mode setting.

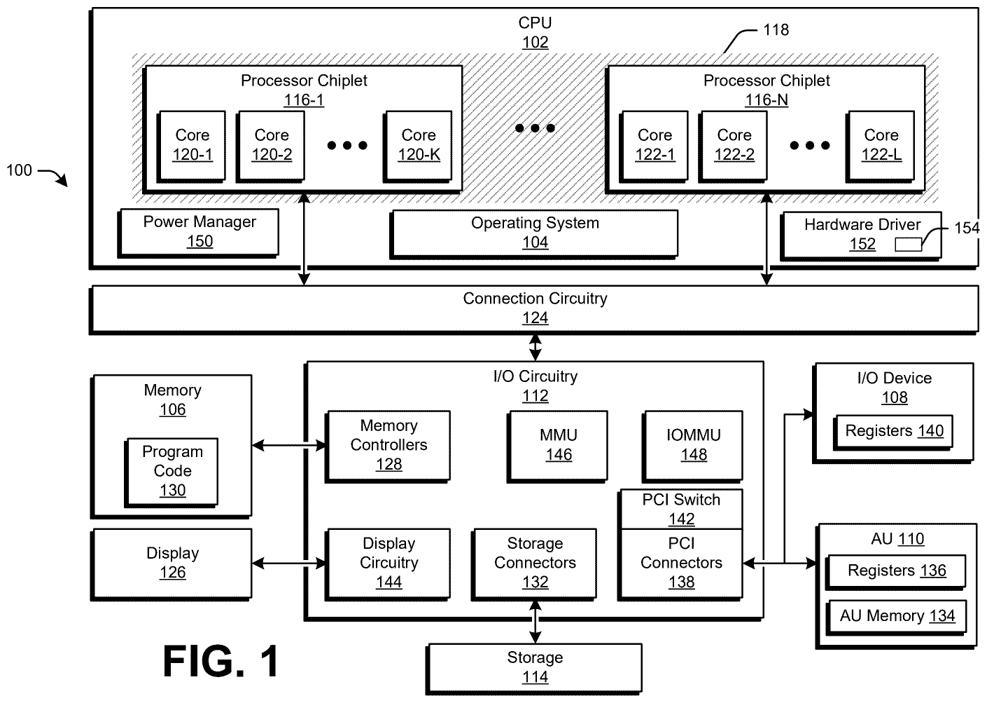

FIG. 1 is a block diagram of a processing system configured to execute one or more applications in accordance with one or more implementations.

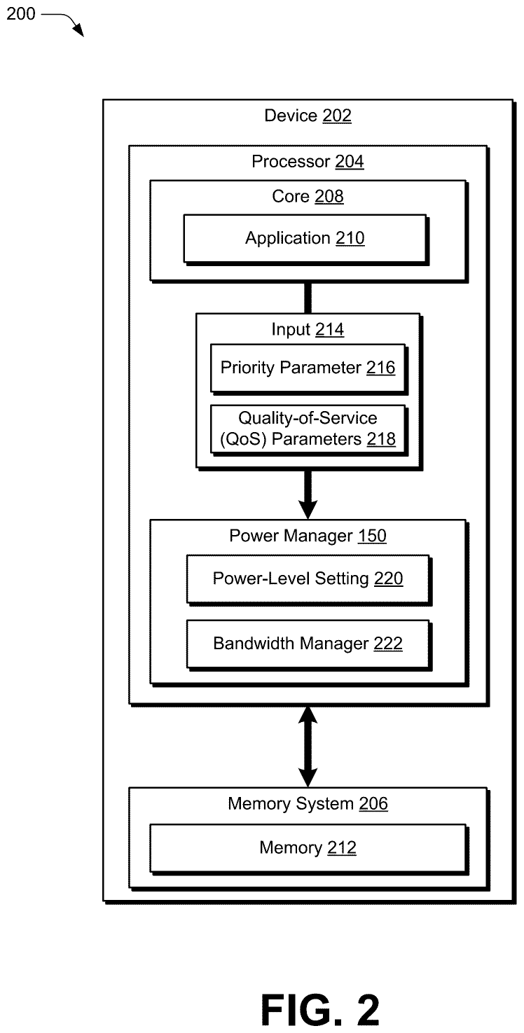

In particular, FIG. 1 includes a processing system 100 configured to execute one or more applications (e.g., application 210 of FIG. 2), such as computing applications (e.g., machine-learning applications, neural network applications, high-performance computing applications, databasing applications, gaming applications), graphics applications, and the like. Examples of devices (e.g., the device 202 of FIG. 2) in which the processing system 100 is implemented include but are not limited to a server computer, personal computer (e.g., desktop or tower computer), smartphone or another wireless phone, tablet or phablet computer, notebook computer, laptop computer, wearable device (e.g., smartwatch, augmented reality headset or device, virtual reality headset or device), entertainment device (e.g., gaming console, portable gaming device, streaming media player, digital video recorder, music or another audio playback device, television, set-top box), Internet of Things (IoT) device, automotive computer or computer for another type of vehicle, networking device, medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 114) for the execution of tasks for the applications, provide an interface to I/O devices (e.g., I/O device 108) for the applications, or any combination thereof.

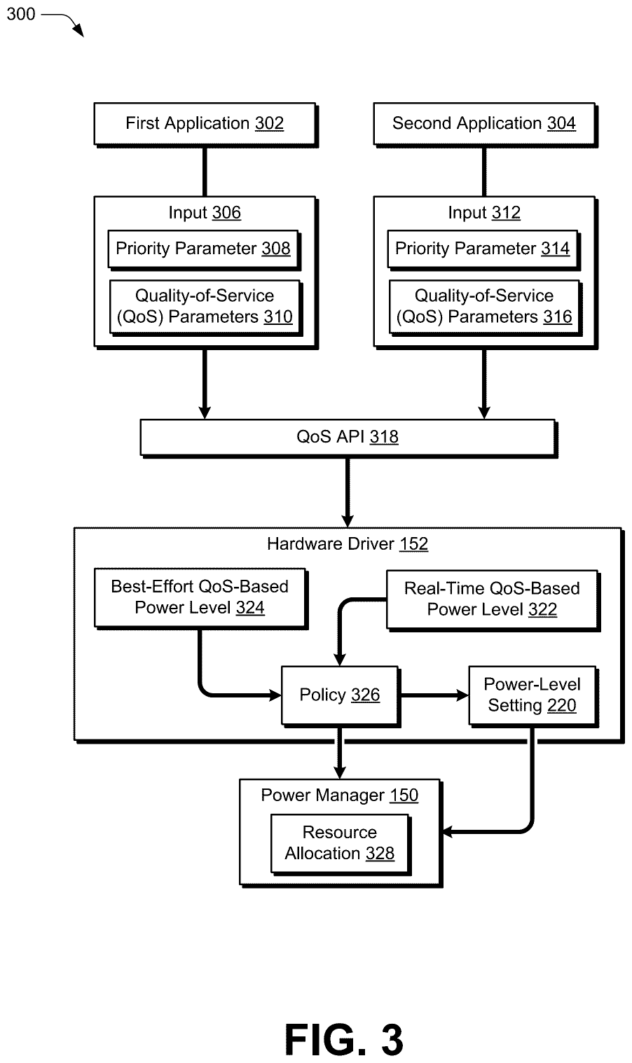

In this example, the power manager 150 with the bandwidth manager 222 of FIG. 2 and the hardware driver 152 with the policy 326 of FIG. 3 are depicted as part of CPU 102. In other implementations, the power manager 150 also includes the power- level setting 220 of FIG. 2. In variations, the power manager 150 or the hardware driver 152 are included in and/or implemented by one or more different components of the processing system 100, such as the AU 110 or the I/O circuitry 112.

The CPU 102 includes one or more processor chiplets 116, which are communicatively coupled by a data fabric 118 in one or more implementations. Each processor chiplet 116, for example, includes one or more processor cores 120, 122 configured to execute one or more series of instructions concurrently, also referred to herein as “threads”, for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116.

Though the example embodiment in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections that are usable to implement the data fabric 118 include but are not limited to buses (e.g., a data bus, a system, an address bus), interconnects, memory channels, and silicon vias, traces and planes. Other example connections include optical connections, fiber optic connections, and/or connections or links based on quantum entanglement.

Additionally, within the processing system 100, the CPU 102 is communicatively coupled to an I/O circuitry 112 by a connection circuitry 124. For example, each processor chiplet 116 of the CPU 102 is communicatively coupled to the I/O circuitry 112 by the connection circuitry 124. The connection circuitry 124 includes, for example, one or more data fabrics, buses, buffers, queues, and the like. The I/O circuitry 112 is configured to facilitate communications between two or more components of the processing system 100 such as between the CPU 102, system memory 106, display 126, universal serial bus (USB) devices, peripheral component interconnect (PCI) devices (e.g., I/O device 108, AU 110), storage 114, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 128. The memory controllers 128, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, the memory controllers 128 are configured to manage access to the data stored at one or more memory addresses within the system memory 106, such as by CPU 102, I/O device 108, and/or AU 110. When an application is to be executed by processing system 100, the OS 104

running on the CPU 102 is configured to load at least a portion of program code 130 (e.g., an executable file) associated with the application from, for example, a storage 114 into system memory 106. This storage 114, for example, includes a non-volatile storage such as a flash memory, solid-state memory, hard disk, optical disc, or the like configured to store program code 130 for one or more applications.

To facilitate communication between the storage 114 and other components of processing system 100, the I/O circuitry 112 includes one or more storage connectors 132 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as AI accelerators or neural processing units (NPUs)), inference engines, machine-learning processors, other multithreaded processing units, scalar processors, serial processors, programmable logic devices (e.g., field-programmable logic devices (FPGAs)), or any combination thereof. For example, an AI processor or machine-learning processor is a specialized hardware chip designed to accelerate AI and machine-learning tasks.

In at least one example, the AU 110 includes one or more compute units that concurrently execute one or more threads of an application and store data resulting from the execution of these threads in AU memory 134. This AU memory 134, for example, includes any combination of one or more volatile memories and/or non-volatile memories, examples of which include caches, video RAM (VRAM), or the like. In one or more implementations, these compute units are also configured to execute these threads based on the data stored in one or more physical registers 136 of the AU 110.

To facilitate communication between the AU 110 and one or more other components of processing system 100, the I/O circuitry 112 includes or is otherwise connected to one or more connectors, such as PCI connectors 138 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 138 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more camera systems (e.g., the digital camera 302 of FIG. 3), keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 140 of the I/O device 108. In one or more implementations, such physical registers 140 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 138, and one or more other components of the processing system 100, the I/O circuitry 112 includes PCI switch 142. The PCI switch 142, for example, includes circuitry configured to route packets to and from the components of the processing system 100 connected to the PCI connectors 138 as well as to the other components of the processing system 100. As an example, based on address data indicated in a packet received from a first component (e.g., CPU 102), the PCI switch 142 routes the packet to a corresponding component (e.g., AU 110) connected to the PCI connectors 138.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 126, or both. The display 126, for example, includes a cathode-ray tube (CRT) display, liquid crystal display (LCD), light emitting diode (LED) display, organic light emitting diode (OLED) display, or any combination thereof. To enable the processing system 100 to display a scene on the display 126, the I/O circuitry 112 includes display circuitry 144. The display circuitry 144, for example, includes high-definition multimedia interface (HDMI) connectors, DisplayPort connectors, digital visual interface (DVI) connectors, USB connectors, and the like, each including circuitry configured to communicatively couple the display 126 to the I/O circuitry 112. Additionally or alternatively, the display circuitry 144 includes circuitry configured to manage the display of one or more scenes on the display 126 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 146 and input-output memory management unit (IOMMU) 148. The MMU 146 includes, for example, circuitry configured to manage memory requests, such as from the CPU 102 to the system memory 106. For example, the MMU 146 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 146 is configured to translate the virtual address indicated in the memory request to a physical address in the system memory 106 and to fulfill the request. The IOMMU 148 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 140 of the I/O device 108, the registers 136 of the AU 110, and/or the AU memory 134, the CPU 102 issues one or more MMIO requests. Such MMIO requests each request access to read, write, fetch, or pre-fetch data residing at one or more virtual addresses (e.g., guest virtual addresses) which each represent at least a portion of the registers 140 of the I/O device 108, the registers 136 of the AU 110, or the AU memory 134, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 148 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

FIG. 2 is a block diagram of a non-limiting example system 200 to implement techniques to provide a CPU performance hint for inference workloads. Specifically, the system 200 depicts a device 202 that includes a processor 204 and a memory system 206 communicatively coupled with one another (e.g., via at least one bus structure, via a network-on-chip, or any type of interconnect that enables transfer of data between various system components described herein).

The techniques described herein are usable by a wide range of device configurations, including, by way of example and not limitation, computing devices, servers, mobile devices (e.g., wearables, mobile phones, tablets, laptops, augmented-reality devices, virtual-reality devices, headsets), processors (e.g., graphics processing units, central processing units, and accelerators), digital signal processors, machine learning inference accelerators, and other apparatus configurations. Additional examples include artificial intelligence training accelerators, cryptography and compression accelerators, network packet processors, and video coders and decoders.

The processor 204 includes at least one core 208, which may also be interchangeably referred to as a processing core. The core 208 is an electronic circuit (e.g., an integrated circuit) that performs various operations on or using data in the memory system 206. Example configurations of the processor 204 and/or core 208 include, but are not limited to, a central processing unit (CPU), graphics processing unit (GPU), field programmable gate array (FPGA), accelerated processing unit (APU), neural network engine (NNE), neural processing unit (NPU), inference processing unit (IPU), and a digital signal processor (DSP). Although one core 208 is depicted in the illustrated example, the processor 204 includes multiple cores 208 (e.g., a multi-core system-on-chip (SoC)).

The core 208 is a processing unit that reads and executes instructions (e.g., of a program), including adding data, moving data, performing computations on data, and branching. In particular, the core 208 executes an application 210 that requires memory access (e.g., to read or write data) to the memory system 206. The application 210 represents any form of software configurable as instructions that are executable by the core 208. In some implementations, application 210 employs machine-learning and other inference models to perform a computing task (e.g., image processing, artificial intelligence functioning) that requires performance resources of the core 208 and/or the processor 204.

The processor 204 also includes a power manager 150 that specifies the configuration of the core 208 for executing the application 210. In particular, the power manager 150 is representative of functionality to control power (e.g., voltage or frequency) and resources allocated for execution of the application 210 by the core 208. To do so, the power manager 150 specifies a variety of characteristics for the core 208, including the number of processing resources, operating frequency, clock speeds, operating voltages, and so forth to be used in executing the application 210.

The power manager 150 is generally implemented in digital circuitry with a combination of hardware and firmware. In some implementations, the power manager 150 is communicatively located between and interfaces with the core 208 and the memory system 206. In another example, the power manager 150 is communicatively coupled to a memory controller that manages the flow of data to and from the memory (e.g., via data fabric or network-on-chip linkage).

Memory system 206 is implemented as a printed circuit board, on which memory 212 (e.g., physical memory) is placed (e.g., via physical and communicative coupling using one or more sockets). In other words, the memory 212 is mounted on a printed circuit board. This construction, along with the communicative couplings (e.g., control signals and buses) and one or more sockets integral to the printed circuit board, form the memory system 206. Examples of the memory system 206 include a TransFlash memory system, single in-line memory module (SIMM), dual in-line memory module (DIMM), small outline DIMM (SO-DIMM), and compression-attached memory system.

In one or more implementations, the memory system 206 is a single integrated circuit device that incorporates the memory 212 on a single chip. In some examples, the memory system 206 is formed using multiple chips of memory 212 that are vertically (“3D”) stacked together, are placed side-by-side on an interposer or substrate, or are assembled via a combination of vertical stacking or side-by-side placement.

Memory 212 is a device or system that is used to store data, such as for immediate use in a device (e.g., by the core 208). In one or more implementations, the memory 212 corresponds to semiconductor memory, where data is stored within memory cells on one or more integrated circuits. In at least one example, memory 212 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 212 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). Allocation of bandwidth or bandwidth guarantees for accessing the memory system 206 by the core 208 and other processing units within the processor 204 is controlled by the power manager 150. Access to the memory system 206 for the core 208 (and other processing units within the processor 204) is generally controlled by a memory controller.

In preparation for executing application 210 (e.g., involving the use of a machine-learning or other inference model), the power manager 150 receives an input 214 from the core 208 or application 210. The input 214 specifies a priority parameter 216 and quality-of-service (QOS) parameters 218 associated with the application 210 or a workload (e.g., collection of instructions, data, and so forth) thereof. The priority parameter 216 indicates the priority of the application's workload. In other words, the priority parameter 216 specifies whether the workload is to be processed in “real-time” or “not real-time” (i.e., “best effort” or “normal”), with real-time priority being higher than “best-effort” priority. For example, the priority parameter 216 indicates a real-time or best-effort (e.g., “normal”) priority for the workload. In other implementations, the priority parameter may include additional priority states. The QoS parameters 218 indicate a throughput (e.g., a framerate of thirty frames-per-second), deadline, or latency (e.g., thirty milliseconds latency) required for the workload. For example, the QoS parameters 218 indicate latency requirements for a CPU to manage and coordinate workload processing by one or more accelerator units 110 for an inference workload of the application 210.

In some implementations, the described techniques and systems extend and modify bandwidth guarantees to ensure the timely execution of inference (and other) workloads under loaded system conditions. The power manager 150 utilizes a bandwidth manager 222 to allocate guaranteed bandwidth to the core 208 and/or application 210 based on the priority parameter 216 and QoS parameters 218. The bandwidth manager 222 initially allocates a guaranteed bandwidth to the core 208 (and other processing units of the processor 204) with generally equal guarantees. If the guarantee is insufficient to satisfy the QoS parameters 218 associated with the application 210, then the bandwidth manager 222 reallocates or reassigns a higher bandwidth guarantee to the core 208 based on the priority parameter 216 and QoS parameters 218. This allows inference workloads to be dynamically assigned priority and QoS-derived bandwidth guarantees to better accommodate the timely execution of the application 210.

Similarly, the power manager 150 assigns a power-level setting 220 for the core 208 (or a portion thereof) based on the priority parameter 216 and the QoS parameters 218 associated with the workload. In another implementation, the power-level setting 220 is further based on the power-level settings or operational data of one or more accelerator units 110 assigned to the same workload. The power-level setting 220 indicates a voltage and frequency setting at which the core 208 (or a portion thereof) operates or will operate to execute the workload of the application 210. This document describes techniques to provide low-power support for inference workloads without impacting power efficiency and battery life of the device 202.

FIG. 3 is a block diagram 300 of an example framework for providing a CPU performance hint for inference workloads. In this example, resource guarantees are provided to ensure QoS specifications are satisfied (to the extent possible) for best-effort or background inference workloads executed by a CPU. In particular, block diagram 300 illustrates resource management for a first application 302 and second application 304 of a CPU with different inference workloads.

A first core or processing unit (not illustrated) of the processor 204 executes the first application 302, which as an example utilizes a large language model to provide cognitive artificial intelligence (AI) workloads. The first application 302 provides an input 306 specifying a first priority parameter 308 and first QoS parameters 310 via a QOS API 318. In the illustrated example, the first priority parameter 308 specifies a real-time priority. The first QoS parameters 310 specify latency and throughput requirements for the workload of the first application 302. In some implementations, the first QoS parameters 310 indicate a deadline or time for completing the inference workload. In other implementations, the first QoS parameters 310 indicate a QoS profile to be utilized, including one of a high, eco, medium, or low profile.

A second core or processing unit (not illustrated) of the processor 204 executes the second application 304, which as an example utilizes a machine-learning model to assist with business productivity tasks. In other implementations, the first application 302 and the second application 304 execute other types of workloads. The second application 304 provides an input 312 specifying a second priority parameter 314 and second QoS parameters 316 via the QOS API 318. In the illustrated example, the second priority parameter 314 specifies a normal or “best-effort” priority. The second QoS parameters 316 specify latency and throughput requirements for the workload of the second application 304.

The QOS API 318 is implemented in this example as part of a runtime that includes an artificial intelligence (AI) runtime and a runtime library. The runtime communicates with a hardware driver 320 having a solver, core, and memory storing precompiled machine-learning models and associated metadata, e.g., resource data. In the illustrated implementation, a single hardware driver 152 is communicatively coupled to the first application 302 and the second application 304. The hardware driver 152 is also communicatively coupled to the power manager 150. In other implementations, separate hardware drivers 152 are associated with each core or processor unit of the processor 204, with each hardware driver 152 communicatively coupled to the power manager 150.

The first application 302, for example, calls the QOS API 318 and provides the first priority parameter 308 as real-time and the first QoS parameters 310. The QoS API 318 provides these parameters to the hardware driver 152. In another implementation, the QOS API 318 provides these parameters to an operating system being run by the processor 204, the core 208, or another processing device of the device 202. As a result, a real-time QoS-based power level 322 is applied and submitted to a policy 326 associated with the first application 302.

The hardware driver 152 dynamically manages the power (e.g., voltage) and clock frequency for the core 208 that processes or executes the workload of the first application 302. A power-level table is also included in the hardware driver 152. The power-level table provides multiple potential power states (e.g., pairs of a voltage and frequency) at which to operate the core 208 (e.g., the IPU or other processing units). For example, the power states of the power-level table include operating frequencies of 2.0 gigahertz (GHz), 1.8 GHz, 1.6 GHz, 1.0 GHZ, 200 MHZ, and so forth. Example voltages in the power-level table range from 0.5 volts (V) to 1.3 V.

The second application 304 calls the QOS API 318 and provides the second priority parameter 314 as best-effort and the second QoS parameters 316. The QOS API 318 provides these parameters to the hardware driver 152. As a result, a best-effort QoS-based power level 324 is applied to the policy 326 associated with the second application 304.

In some implementations, a power manager driver or other circuitry also informs the hardware driver 152 or the policy 326 of potential power states currently available for the hardware unit (e.g., a power-level table with voltage and frequency pairs). In some implementations, the potential power states depend on a current power-slider position and/or power source (e.g., AC versus DC). In one example, a power slider is a graphical user interface element that allows users to identify or adjust the power state or power-level settings associated with the device 202 (e.g., to balance performance and battery life). Different potential power-slider positions include, for example, “best battery life” or “best power efficiency” setting to prioritize battery life, “better battery” setting to balance performance and battery life, “better performance” setting to prioritize performance, and “best performance” setting to maximize performance by using the highest possible power-level settings. The “better battery” and “better performance” are examples of balanced power efficiency and performance settings. In other implementations, the power-slider positions can include additional or fewer settings or be known by different names.

The hardware driver 152 (or the operating system) then assigns a particular power-level setting 220 to the first application 302 and the second application 304, respectively, based on the policy 326. The performance hint for each application can be part of a hardware driver associated with the processor 204 or the core 208 or part of the operating system and be based on workload priority (e.g., background, foreground, idle, in-focus, etc.) For example, the first application 302 (with real-time priority) is guaranteed power levels such that the first QoS parameters 310 are satisfied. In addition, resource prioritization is extended to the second application 304 (with best-effort priority and specified QoS parameters) to attempt to satisfy the second QoS parameters 316 as long as they do not contradict power-slider or power-source policies. If no QoS parameters are provided, the associated workload is assigned a power level associated with the current power slider or power source policy.

The hardware driver 152 provides the policy 326 and power-level setting 220 associated with the first application 302 and the second application 304, respectively, to the power manager 150. The power-level setting 220 may include any of the following power modes: performance, balanced, efficiency, battery, and AC/DC. The power manager 150 determines a resource allocation 328 for the first application 302 and the second application 304, respectively, based on the corresponding power-level setting 220, QoS parameters, and policy 326. The resource allocation 328 indicates a voltage and/or operating frequency utilized for each application. In this way, the power manager 150 extends resource guarantees and/or prioritization to best-effort applications (e.g., the second application 304). The resource allocation 328 for the second application 304 (and other best-effort or background inference applications) can be optimized based on balancing performance requirements against power efficiency. The hardware driver 152 may also include a performance monitor for the first application 302 and the second application 304 to evaluate the performance of inference workloads in comparison to the QoS parameter. The hardware driver 152 may also monitor the resource allocation and operational characteristics of one or more accelerator units 110 assisting with the first application 302 and/or the second application 304 to update the resource allocation 328 for the corresponding processor core or CPU.

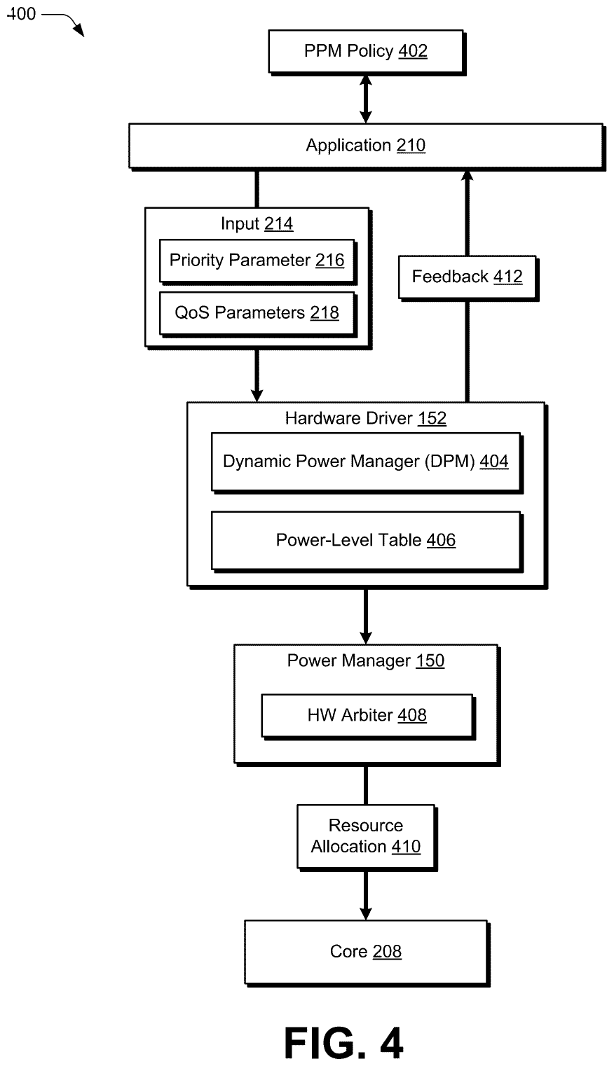

FIG. 4 is a block diagram of an example system 400 showing the operation of a power manager and a hardware driver to provide a CPU performance hint for inference workloads. In system 400, power-level and resource arbitration for application 210, which utilizes a machine-learning model to perform an AI workload, is illustrated.

Application 210 is configured to bi-directionally communicate a processor-power-management (PPM) policy 402 for the AI workload with core 208 (not illustrated). The PPM policy 402 indicates a QoS profile for the core 208. As described above, the application 210 provides an input 214 to the hardware driver 152. The input 214 includes priority parameter 216 and QoS parameters 218 for the AI workload.

In another implementation, input 214 also includes resource data, which provides insights into the resources required for processing the workload. The workload in this implementation is deterministic, and by leveraging this, the resource data includes workload statistics that are determined and characterized during a compilation stage in generating the precompiled machine-learning models. The workload statistics are configurable as a serialized graph representation that describes resource consumption by the machine-learning models (e.g., a number of operations, data movement between layers of the model, and so forth). The power manager 150 is thus configured in this implementation to utilize indications by the QoS parameters 218 and priority parameter 216 to determine a minimum amount of CPU resources to be allocated to process the workload.

The hardware driver 152 includes a dynamic power manager (DPM) 404 that provides dynamic power management for the core 208. In particular, the DPM 404 enables the application 210 to specify the priority parameter 216 and QoS parameters 218 for processing the workload. A power-level table 406 is also included in the hardware driver 152. The power-level table 406 provides multiple potential power states (e.g., pairs of a voltage and frequency) at which to operate the core 208 (e.g., the IPU or other processing units). For example, the power states of the power-level table 406 include operating frequencies of 2.0 gigahertz (GHz), 1.8 GHz, 1.6 GHz, 1.0 GHz, 200 MHz, and so forth. Example voltages in the power-level table 406 range from 0.5 volts (V) to 1.3 V.

The hardware driver 152 is communicatively coupled to the power manager 150 and provides the priority parameter 216 and QoS parameters 218 associated with the AI workload to a hardware (HW) arbiter 408, which represents logic of the power manager 150 to assign power level characteristics for the application 210. Based on the priority state (e.g., real-time versus best-effort) indicated by the priority parameter 216, the hardware arbiter 408 selects either a hard-minimum (e.g., “hardmin”) or soft-minimum (e.g., “softmin”) operating state to provide to a hardware controller, which controls the power level (e.g., operating frequency and voltage) of the core 208, other processor units, or partitions thereof. The power manager 150 and/or hardware arbiter 408 may also use power-slider-based tuning and controls of the duty cycle, frequency, voltage, and other resource allocations 410 of the core 208 to manage the operation of background or best-effort inference workloads. The hardware driver 152 can also provide a hint to the power manager 150 to adapt the scheduling of tasks and applications by the core 208 and/or the accelerator units 110 when power limits are being approached by the core 208.

In particular, a real-time priority is associated with or assigned the “hardmin” operating state that results in the QoS parameters 218 associated with a workload being satisfied, even at the expense of other workloads or applications via throttling. The “hardmin” operating state results in the workload being assigned a power level within the power-level table 406 that satisfies the QoS parameters 218. Often, such workloads are assigned the lowest power level within the power-level table 406 that satisfies the QoS parameters 218 to promote power efficiency.

A best-effort priority is associated with or assigned the “softmin” operating state. Under the “softmin” operating state, if the power level determined by the QoS parameters 218 is lower than a power-mode-derived power level, then the lower best-effort QoS-derived power level is selected for the core 208 to save power. In contrast, if the power level determined by the QoS parameters 218 is higher than a power-mode-derived power level, then the power-mode-derived power level is selected to satisfy the power-mode policy. If a workload does not specify any QoS parameters 218, then a default power-mode-derived power level is used.

The hardware driver 152 also provides feedback 412 to the application 210 based on the assigned power level, power-mode policies, and/or resource allocation 410. In particular, the feedback 412 includes an indication of the throttling of and resource guarantees for the core 208.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the processor 204, the application 210, and power manager 150) are implemented in any of a variety of different manners such as hardware circuitry, software or firmware executing on a programmable processor, or any combination of two or more of hardware, software, and firmware. The methods provided are implemented in a variety of devices, such as a processor or processor core. Suitable processors include, by way of example, a special-purpose processor, inference processing unit, accelerated processing unit, digital signal processor (DSP), neural network engine (NNE), graphics processing unit (GPU), parallel accelerated processor, multiple microprocessors, one or more microprocessors in association with DSP cores, controllers, microcontrollers, Application Specific Integrated Circuits (ASICs), Field Programmable Gate Arrays (FPGAs) circuits, other types of integrated circuits (ICs), and/or state machines.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include read-only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A device comprising:
a power manager configured to:
send a priority parameter and a quality-of-service (QOS) parameter for processing an inference workload of the application;
configure a processor core of a central processing unit of the device to process the inference workload at a first power setting among multiple power settings based on the priority parameter and the QoS parameter; and
adjust the first power setting to a second power setting among the multiple power settings based on a performance of the inference workload in comparison to the QoS parameter.

2. The device of claim 1, wherein the power manager is further configured to assign the second power setting based on a power setting assigned to one or more other hardware compute units of the device to perform additional processing of the inference workload.

3. The device of claim 2, wherein the processor core is configured to manage the additional processing of the inference workload by the one or more other hardware compute units.

4. The device of claim 3, wherein the one or more other hardware compute units include at least one of graphics processing units, neural processing units, artificial intelligence processors, inference engines, machine-learning processors, accelerator units, or programmable logic devices.

5. The device of claim 3, wherein the power manager is further configured to receive operation data that describes operation characteristics of the processor core and the one or more other hardware compute units and determine the first power setting based at least in part on the priority parameter, the QoS parameter, and the operation data.

6. The device of claim 1, wherein the power manager is further configured to:
in response to the priority parameter indicating a best-effort priority, the QoS parameter specifying a latency or throughput for the inference workload, and a power-mode setting being satisfied by the processor core, assign a soft-minimum power setting associated with the inference workload that ensures the QoS parameter is satisfied.

7. The device of claim 6, wherein the power-mode setting is based on:
whether the device is powered by alternating-current (AC) power or direct-current (DC) power; or
a power-slider position for the central processing unit, the power-slider position including at least two of a best power efficiency setting, one or more balanced power efficiency and performance settings, or a best performance setting.

8. The device of claim 6, wherein the power manager is further configured to, in response to the application not specifying the QoS parameter, assign no minimum power setting associated with the inference workload and determine the first power setting based on the power-mode setting.

9. A method comprising:
receiving an input from an application, the input specifying a priority parameter for processing an inference workload associated with the application;
determining, based at least in part on the priority parameter, a first power setting from among multiple power settings to process the inference workload, each power setting of the multiple power settings identifying a voltage and a frequency at which to operate a processor core of a central processing unit in a device; and
processing the inference workload from the application by the processor core at the first power setting.

10. The method of claim 9, wherein the method further comprises:
in response to the priority parameter indicating a real-time priority and the input also specifying a quality-of-service (QOS) parameter for the inference workload, assigning a second power setting from among the multiple power settings to the processor core to process the inference workload that satisfies the QoS parameter;
in response to the priority parameter indicating a best-effort priority and the input also specifying the QoS parameter for the inference workload, assigning a third power setting to the processor core to process the inference workload that satisfies the QoS parameter or a power mode of the central processing unit; or
in response to the input not specifying the QoS parameter for the inference workload, assigning a fourth power setting that satisfies the power mode.

11. The method of claim 10, wherein:
in response to a power setting based on the power mode consuming more power than a power setting based on the QoS parameter, the power setting based on the QoS parameter is selected as the third power setting; or
in response to the power setting based on the QoS parameter consuming more power than the power setting based on the power mode, the power setting based on the power mode is selected as the third power setting.

12. The method of claim 10, wherein:
the multiple power settings are arranged in a power-level table by descending amounts of power consumption per power setting; and
potential power settings available in the power-level table are determined at least in part by the power mode of the central processing unit and one or more other hardware compute units associated with processing of the inference workload.

13. The method of claim 9, wherein:
the method further comprises receiving workload statistics describing the inference workload; and
determining the first power setting is based at least in part on the priority parameter and the workload statistics.

14. The method of claim 13, wherein the workload statistics specify a number of operations or amount of data movement to be performed by the processor core or one or more other hardware compute units.

15. The method of claim 14, wherein the workload statistics are determined based on prior knowledge of processing the inference workload by the processor core and the one or more other hardware compute units.

16. The method of claim 9, wherein the inference workload includes execution of a machine-learning model selected from a plurality of precompiled machine-learning models.

17. The method of claim 9, wherein:
the method further comprises receiving operation data that describes operating characteristics of one or more other hardware compute units in the device; and
determining the first power setting is based at least in part on the priority parameter and the operation data of the one or more other hardware compute units.

18. The method of claim 17, wherein the one or more other hardware compute units include at least one of graphics processing units, neural processing units, artificial intelligence processors, inference engines, machine-learning processors, accelerator units, or programmable logic devices.

19. A central processing unit comprising:
a power manager configured to:
receive an input from an application that specifies a priority parameter, a quality-of-service (QOS) parameter, and workload statistics for processing an inference workload of the application to be processed by a processor core of multiple processor cores; and
determine a power setting of the processor core to process the inference workload, the power setting determined to minimize power consumption in processing the inference workload and based at least in part on the workload statistics, the priority parameter, and the QoS parameter; and
the processor core of the multiple processor cores, the processor core configured to:
generate a partition in the processor core based on the power setting; and
process the inference workload using the generated partition.

20. The central processing unit of claim 19, wherein the power manager is further configured to:
in response to the priority parameter indicating a real-time priority and the QoS parameter being specified, determine the power setting to ensure satisfaction of the QoS parameter;
in response to the priority parameter indicating a best-effort priority and the QoS parameter being specified, determine the power setting to ensure satisfaction of the QoS parameter or compliance with a power-mode setting associated with the processor core; or
in response to the QoS parameter not being specified, determine the power setting to ensure compliance with the power-mode setting.
